(19) United States
(12) Patent Application Publication
(10) Pub. No.: US 2010/0014566 A1
(43) Pub. Date: Jan. 21, 2010

(54) METHOD AND APPARATUS FOR A 10GBASE-T SMALL FORM FACTOR PLUGGABLE (SFP+) MODULE

(76) Inventors: Amir Mezer, Haifa (IL); Adee Ofir Ran, (US)

Correspondence Address: INTEL/BSTZ;BLAKELY SOKOLOFF TAYLOR & ZAFMAN LLP, 1279 OAKMEAD PARKWAY, SUNNYVALE, CA, 94085-4040, US

(21) Appl. No.: 12/176,910

(22) Filed: Jul. 21, 2008

(51) Int. Cl. H04B 1/38

(52) U.S. Cl. 375/220

(57) ABSTRACT

A 10GBase-T Small Form Factor Pluggable (SFP+) module. The 10GBase-T SFP+ module has a 10GBase-T physical layer (PHY) module with a communication interface and an interface module with SFP+ high speed serial electrical interface (SFI). During receive operation, 10GBase-T data is received from a link partner via the communication interface. The 10GBase-T PHY module processes the 10GBase-T data into intermediate data. The interface module receives the intermediate data from the 10GBase-T PHY module, processes the intermediate data into 10GBase-R data, and outputs the 10GBase-R data to a SFI host via the SFI. During transmit operation, 10GBase-R data is transmitted by a SFI host via the SFI. The interface module processes the 10GBase-R data into intermediate data. The 10GBase-T PHY receives the intermediate data from the interface module, processes the intermediate data into 10GBase-T data, and outputs the 10GBase-T data to a link partner via the communication interface.

### FIELD OF THE INVENTION

This invention relates to a Small Form Factor Pluggable module, and more specifically but not exclusively, to a SFP+ module with 10GBase-T connectivity.

### BACKGROUND DESCRIPTION

As the demand for data storage increases, datacenters require high-speed connections among servers, switches and clients to reduce the time for data transfer. There are several connectivity methods employed by datacenters and these methods differ by their range and cost. One such method employed by datacenters uses Small Form Factor Pluggable (SFP+) standard (SFF Committee, “SFF-8431 Specifications for Enhanced 8.5 and 10 Gigabit Small Form Factor Pluggable Module “SFP+””, Rev 3.0, May 2008) modules to connect among servers, switches and clients.

SFP+ is a proposed standard for modules that implement the physical layer of a 10 Gigabits per second communication link. The SFP+ standard defines the mechanical, electrical and thermal requirements for the modules. It is a successor in a line of previous standards and targets higher data density that demands lower power and smaller form factor than previous standards.

SFP+ enables separation between the physical layer (typically a medium-dependent optical module) and the upper layers, which can be implemented in medium-independent Application Specific Integrated Circuits (ASICs) on Network Interface Cards (NICs) and switches. SFP+ standard modules use optical communication based on 10GBase-SR (Short Range), 10GBase-LR (Long Range) (the Institute of Electrical and Electronics Engineers (IEEE) 802.3 standard, “IEEE 802.3-2005 standard”, published 9 Dec. 2005) and 10GBase-LRM (Long Reach Multimode) (the IEEE 802.3aq standard, “IEEE 802.3aq-2006 standard”, published 16 Oct. 2006)

FIG. 1 illustrates an example of a host board 100 connected to a SFP+ standard module 120 via connector 130. The host board contains an ASIC Serializer/Deserializer (SerDes) module 110. SFP+ high speed serial electrical interface (SFI) is the high speed serial electrical interface protocol for SFP+ standard modules that operates at nominal baud rate of 9.95-11.1 Gigabits per second. The host equalizer module 112 receives data from the receive driver 122 of the SFP+ standard module 120 via the differential pair SFI link 150 and 152. The pre-emphasis module 114 transmits data from ASIC SerDes module 110 to the transmit driver 124 of the SFP+ standard module 120 via the differential pair SFI link 154 and 155. The SFP+ standard module 120 connects to a link partner via fiber optic cables using a hot-pluggable optical connector. The optical detector 126 receives data from the link partner and the laser 128 transmits data to the link partner. The SFP+ standard module 120 is hot-pluggable in its enclosure on the host board 100 so that the SFP+ standard module 120 can be exchanged according to requirements in order to support short reach or long reach optical media. The type of the SFP+ standard module 120 should match the type of the fiber optic cable. For example, if the fiber optic cable is multimode, the SFP+ standard module 120 should operate in accordance with 10GBase-SR.

However, a disadvantage with the SFP+ standard is the high cost of the optical components such as lasers within the SFP+ standard module. Efforts have been made to reduce the cost by replacing the fiber optic cables with twin-axial cables which do not require optical components in the module. However, there are also disadvantages with replacing the fiber optic cables with twin-axial cables. The twin-axial cable solution connects two SFP+ modules and the two modules are not detachable from the cable. The twin-axial cable solution poses extra requirements on both partners as the solution is not fully standardized and is loosely based on 10GBASE-LRM. Although twin-axial cables may be of lower cost than the optical components, the inflexibility of the twin-axial cables may pose a problem, especially when the twin-axial cables need to be bent for storing in the datacenters. In addition, twin-axial cables are also currently more expensive than twisted-pair cables.

Another possible alternative that may be considered is the standardized 10GBase-T solution that operates over twisted-pair copper. However, the standard 10GBase-T solution is also not ideal due to its high power consumption.

### BRIEF DESCRIPTION OF THE DRAWINGS

The features and advantages of embodiments of the invention will become apparent from the following detailed description of the subject matter in which:

FIG. 1 illustrates a host board with a SFP+ module (prior art);

FIG. 2 illustrates one embodiment of the invention in master mode;

FIG. 3 illustrates the same embodiment of the invention of FIG. 2 in slave mode;

FIG. 4 illustrates a 10GBase-T PHY in accordance with one embodiment of the invention;

FIG. 5 illustrates a digital processor according to one embodiment of the invention; and

FIG. 6 illustrates an analog front end according to one embodiment of the invention.

### DETAILED DESCRIPTION

Reference in the specification to “one embodiment” or “an embodiment” of the invention means that a particular feature, structure or characteristic described in connection with the embodiment is included in at least one embodiment of the invention. Thus, the appearances of the phrase “in one embodiment” appearing in various places throughout the specification are not necessarily all referring to the same embodiment.

Embodiments of the invention address the need for a low cost and low power consumption of the implementation of the SFP+ standard. In one embodiment of the invention, the SFP+ standard module is modified by replacing the optical components with a 10GBase-T physical layer (PHY) module based on the IEEE 802.3an standard, “IEEE 802.3an-2006 standard”, published 1 Sep. 2006. The 10GBase-T PHY module uses low cost and flexible twisted pair copper cables such as Category 5, 5E, 6, 6A, 7 or any future cabling standard that is supported by IEEE 802.3an.

By using existing IEEE 802.3an standard, the disruptions of datacenters to switch from using the SFP+ standard module with optical connectivity to a SFP+ module with 10GBase-T connectivity are minimal. At the same time, the cost of the 10GBase-T SFP+ module is lower compared to SFP+ modules with fiber optic or twin-axial cables.

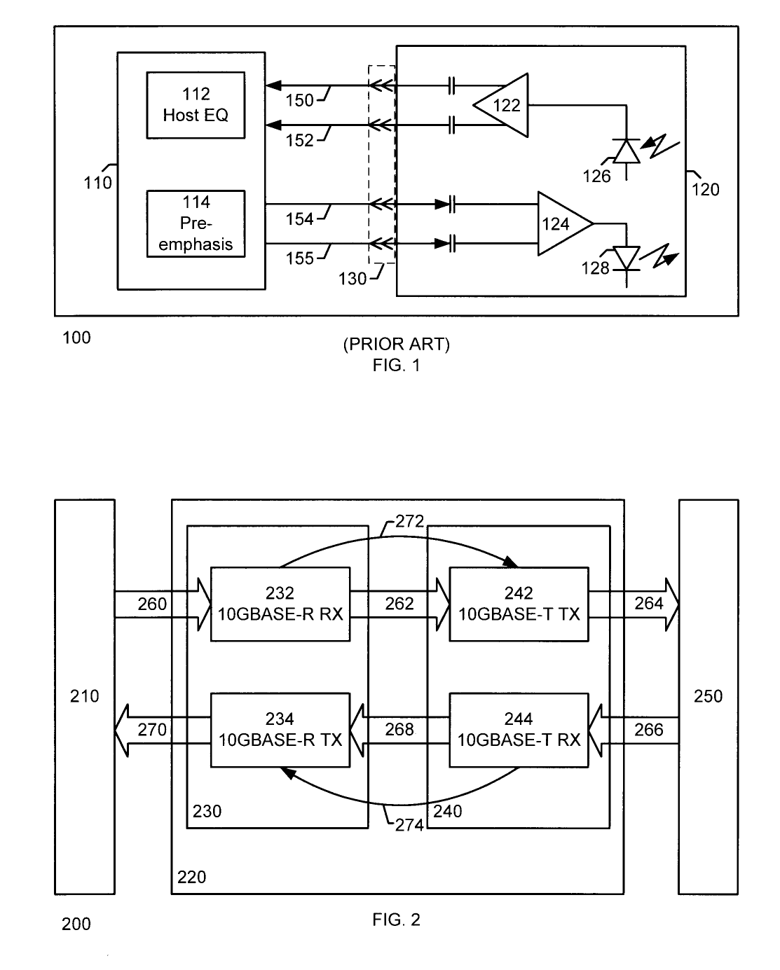

FIG. 2 illustrates one embodiment of a system 200 of the datacenter. System 200 consists of a SFI host 210 connected to a 10GBase-T SFP+ module 220 via the differential pair SFI link 260 and 270. In one embodiment, the SFI host 210 includes the ASIC SerDes module 110 described in FIG. 1. The SFI host includes, but is not limited to, a server, a switch, a router, or any machine with SFI. The 10GBase-T SFP+ module 220 has an interface module 230 and a 10GBase-T PHY module 240. System 200 also has a link partner 250 connected to the 10GBase-T SFP+ module 220 via communication links 264 and 266. Although communication links 246 and 266 are shown as separate links, it is apparent to one skilled in the relevant art that communication links 246 and 266 can be implemented as a single bidirectional link. The link partner includes, but is not limited to, a server, a switch, a router, or any machine with SFI. The communication links 264 and 266 includes, but are not limited to, unshielded and shielded twisted pair cables operating in accordance with cabling standard of Category 5, 5E, 6, 6A, 7 or any future cabling standard.

The interface module 230 has two units, namely, 10GBase-R Receive (RX) unit 232 and 10GBase-R Transmit (TX) unit 234. Both units operate in accordance with IEEE Standard 802.3ae and IEEE Standard 802.3ae is supported by SFP+ standard. The 10GBase-T PHY module 240 has two units, namely, 10GBase-T TX unit 242 and 10GBase-T RX unit 244. Both units operate in accordance with IEEE Standard 802.3an. The interface module 230 communicates with the 10GBase-T PHY module 240 using communication links 262 and 268. In one embodiment, the communication links 262 and 268 operate in accordance with, but are not limited to, 10 Gigabit Media Independent Interface (XGMII), X Attachment Unit Interface (XAUI) or any other communication interface.

During a transmit operation from the SFI host 210 to the link partner 250 in the system 200, the SFI host 210 sends incoming 10GBase-R data to the 10GBase-R RX unit 232 in the interface module 230 via the SFI link 260. The 10Gbase-R RX unit 232 receives the incoming 10GBase-R data and process the incoming 10GBase-R data into outgoing intermediate data. After processing, the outgoing intermediate data is sent to the 10GBase-T TX unit 242 in the 10GBase-T SFP+ module 240 via communication link 262. The processing of the incoming 10GBase-R data operates in accordance with the protocol of communication link 262. In one embodiment when communication link 262 operates in accordance with XGMII, the 10Gbase-R RX unit 232 processes the incoming 10GBase-R data into outgoing XGMII data.

The 10GBase-T TX unit 242 receives the outgoing intermediate data and processes the outgoing intermediate data into outgoing 10GBase-T data. After processing, the outgoing 10GBase-T data is sent to the link partner 250 via communication link 264. In some embodiments, the 10GBase-T TX unit 242 converts the outgoing intermediate data into XAUI data before processing the outgoing intermediate data into outgoing 10GBase-T data. The link partner receives the outgoing 10GBase-T data via communication link 264.

The receive operation from the link partner 250 to the SFI host 210 in the system 200 is similar to the transmit operation described earlier. During the receive operation, the link partner 250 sends incoming 10GBase-T data to the 10GBase-T RX unit 244 in the 10GBase-T SFP+ module 240 via communication link 266. The 10Gbase-T RX unit 244 receives the incoming 10GBase-T data and processes the incoming 10GBase-T data into incoming intermediate data. After processing, the incoming intermediate data is sent to the 10GBase-R TX unit 234 in the interface module 230 via communication link 268. The processing of the incoming 10GBase-T data operates in accordance with the protocol of communication link 268. In one embodiment when communication link 268 operates in accordance with XGMII, the 10Gbase-T RX unit 244 processes the incoming 10GBase-T data into incoming XGMII data.

The 10GBase-R TX unit 234 receives the incoming intermediate data and processes the incoming intermediate data into outgoing 10GBase-R data. After processing, the outgoing 10GBase-R data is sent to the SFI host 210 via communication link 270. In some embodiments, the 10GBase-T RX unit 244 converts the incoming 10GBase-T data into XAUI format before processing the incoming 10GBase-T data into intermediate data. The SFI host 210 receives the outgoing 10GBase-R data via communication link 270.

The timing modes of the 10GBase-T SFP+ module 220 and the link partner 250 are determined by the auto-negotiation protocol governed by IEEE802.3an standard. In the system 200, the 10GBase-T SFP+ module operates in master mode and the link partner 250 operates in slave mode. During the transmit operation described earlier, the 10GBase-R RX unit 232 generates the clock 272 that the 10GBase-T TX unit 232 operates in accordance with. During the receive operation described earlier, the 10GBase-T RX unit 244 generates the clock 274 that the 10GBase-R TX unit 234 operates in accordance with. In one embodiment, clocks 272 and 274 operate with different frequencies. In another embodiment, clocks 272 and 274 operate with the same frequencies.

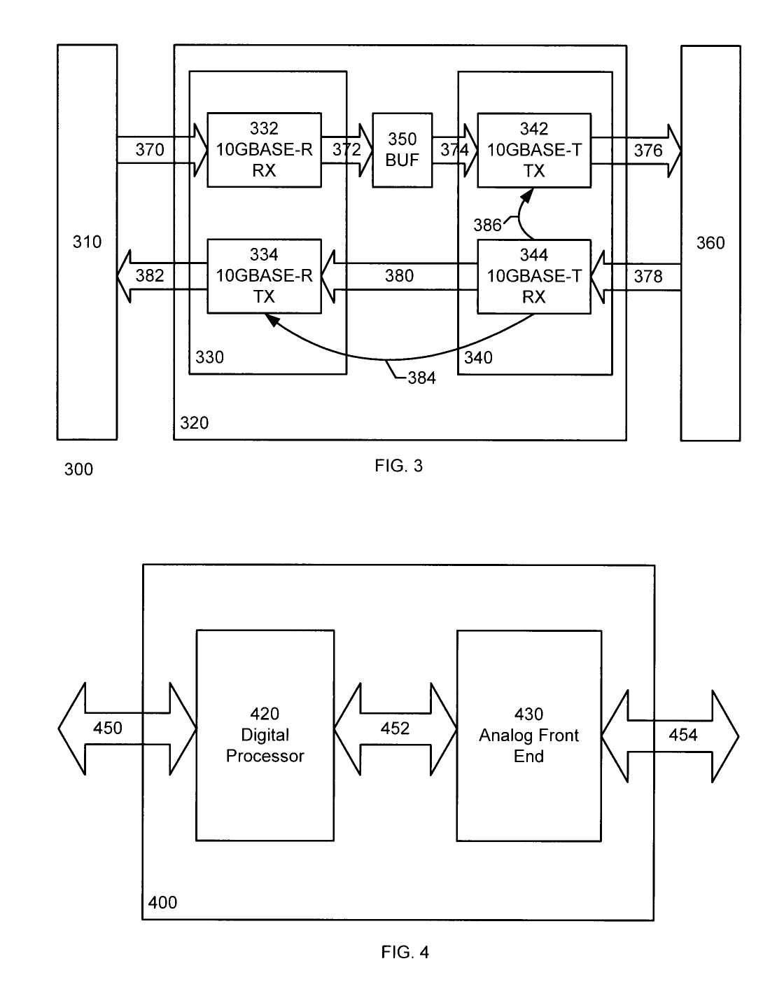

FIG. 3 illustrates the same embodiment of the invention as FIG. 2 in a system 300 of the datacenter. System 300 has a SFI host 310 connected to a 10GBase-T SFP+ module 320 via the differential pair SFI link 370 and 382. In one embodiment, the SFI host 310 includes the ASIC SerDes module 110 described in FIG. 1. The 10GBase-T SFP+ module 320 has an interface module 330, a buffer 350, and a 10GBase-T PHY module 340. System 300 also has a link partner 360 connected to the 10GBase-T SFP+ module 320 via communication links 376 and 378. Although communication links 376 and 378 are shown as separate links, it is apparent to one skilled in the relevant art that communication links 376 and 378 can be implemented as a single bidirectional link. The communication links 376 and 378 include, but are not limited to, unshielded and shielded twisted pair cables operating in accordance with cabling standard of Category 5, 5E, 6, 6A, 7 or any future cabling standard.

The interface module 330 is similar to the interface module 230 described earlier and a discussion of the operation is not repeated herein. The 10GBase-T PHY module 340 is similar to the 10GBase-T PHY module 240 described earlier and thus a discussion of the operation is also not repeated herein. In one embodiment, the communication links 372, 374 and 380 operate in accordance with, but are not limited to, 10 Gigabit Media Independent Interface (XGMII), X Attachment Unit Interface (XAUI) or any other communication interface.

In system 300, the 10GBase-T SFP+ module 320 operates in slave mode and the link partner 360 operates in master mode. During the receive operation, the 10GBase-T RX unit 344 generates the clock 384 that the 10GBase-R TX unit 334 operates in accordance with. During the transmit operation, the 10GBase-T RX unit 344 generates the clock 386 that drives the 10GBase-T TX unit 342. However, the transmitted data from the 10GBase-R RX unit 332 has its own clock domain and is not synchronized with the 10GBase-T TX unit 342. Therefore there is a need to adjust the transmission data rate between the 10GBase-R RX unit 332 and the 10GBase-T TX unit 342. The buffer 350 synchronizes the data rate between the 10GBase-R RX unit 332 and the 10GBase-T PHY module 340. In one embodiment, clocks 384 and 386 operate with the same frequencies.

In one embodiment, the rate adjustment by the buffer 350 uses a mechanism of Inter-Packet Gap (IPG) defined in the IEEE 802.3 standard. The 10GBase-R RX unit 332 transmits data in packets and between two consecutive packets, an IPG with idle bytes are transmitted with a specified minimum length. When the receive clock from the 10GBase-R RX unit 332 is slower than the transmit clock 386, some idle byes are inserted into the outgoing intermediate data sent via communication link 374 by the buffer 350 since the incoming 10GBase-R data received via communication link 372 has a slower rate. When the receive clock is faster than the transmit clock 386, some idle byes are removed from the outgoing intermediate data sent via communication link 374 by the buffer 350 since the incoming 10GBase-R data received via communication link 372 has a faster rate. In other embodiments, the rate adjustment by the buffer 350 may use other methods that synchronize the data rate between the interface module 330 and the 10GBase-T PHY module 340.

During a transmit operation from the SFI host 310 to the link partner 360 in the system 300, the SFI host 310 sends incoming 10GBase-R data to the 10GBase-R RX unit 332 in the interface module 330 via the SFI link 370. The 10Gbase-R RX unit 332 receives the incoming 10GBase-R data and processes the incoming 10GBase-R data into outgoing intermediate data. After processing, the outgoing intermediate data is sent to the buffer 350 via communication link 372. The buffer 350 inserts or removes idle bytes from the outgoing intermediate data based on the difference between transmit and receive clock frequency as discussed earlier.

The buffer sends the outgoing intermediate data after processing to the 10GBase-T TX unit 342 in the 10GBase-T PHY module 340 via communication link 374. The processing of the incoming 10GBase-R data operates in accordance with the protocol of communication link 372. In one embodiment when communication link 372 operates in accordance with XGMII, the 10Gbase-R RX unit 332 processes the incoming 10GBase-R data into outgoing XGMII data.

The 10GBase-T TX unit 342 receives the outgoing intermediate data and processes the outgoing intermediate data into outgoing 10GBase-T data. After processing, the outgoing 10GBase-T data is sent to the link partner 360 via communication link 376. In some embodiments, the 10GBase-T TX unit 342 converts the outgoing intermediate data into XAUI format before processing the outgoing intermediate data into outgoing 10GBase-T data. The link partner receives the outgoing 10GBase-T data via communication link 376.

The receive operation from the link partner 360 to the SFI host 310 in the system 300 is similar to the receive operation described earlier in system 200 and thus a discussion of such is not repeated herein. Although the systems 200 and 300 show only one SFI host, one 10GBase-T SFP+ module, and one link partner, one of ordinary skill in the relevant art will appreciate that there can be more than one SFI host, 10GBase-T SFP+ module, and link partner.

FIG. 4 shows an implementation of a 10GBase-T PHY module 400 in accordance with one embodiment of the invention. The 10GBase-T PHY module 400 has two units, namely, digital processor 420 and Analog Front End (AFE) 430. Communication link 450 shows a bidirectional interface that is similar to communication links 262 and 268 in FIG. 2 and communication links 374 and 380 in FIG. 3. The digital processor 420 and the AFE 430 are connected via communication link 452. Communication link 454 shows a bidirectional interface that is similar to communication links 264 and 266 in FIG. 2 and communication links 376 and 378 in FIG. 3. The detailed workings of a 10GBase-T PHY module is not described herein as it is apparent to one skilled in the relevant art.

SFP+ standard stipulates that the maximum power dissipation for SFP+ modules must meet either SFP+ power level one of up to 1 Watt or SFP+ power level two of up to 1.5 Watts. However, the standard 10GBase-T PHY module dissipates more power than the requirements of SFP+. Therefore, the standard 10GBase-T PHY is modified to reduce the power dissipation to meet the requirements of SFP+ level one or two. The modifications may create a 10GBASE-T PHY that is not strictly standard, as it may not operate over the full distance required by IEEE 802.3an standard. However, the modified 10GBASE-T PHY is compatible with the standard requirements for short lengths of the twisted-pair cable, and can communicate successfully with any link partner 250 or 360 that is either a standard or a modified 10GBASE-T PHY.

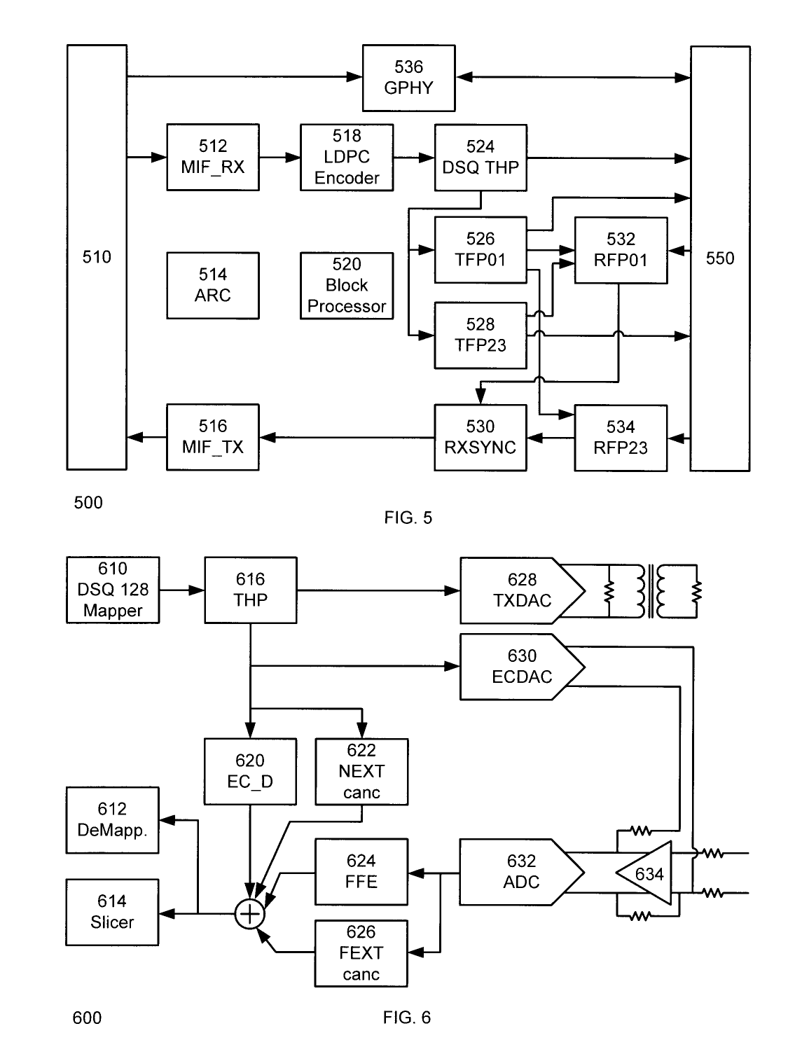

FIG. 5 shows a digital processor 500 of a modified 10GBase-T PHY module in accordance with one embodiment of the invention. The LDPC decoder that normally couples the RXSYNC 530 to the MIF_TX 516 in the prior art is removed to limit the power level of the 10GBase-T SFP+ module. Doing so allows the digital processor 500 to meet the power requirements of SFP+ power level one or two. Given the LDPC decoder is removed, the RXSYNC 530 is directly connected to the MIF transmit module 516. The coded word sent by RXSYNC 530 is composed of the original data bits with parity bits appended. By eliminating the LDPC decoder, the coded word is decoded by simple bit selection and discarding the parity bits. This saves both decoding logic and data buffers, resulting in lower area and power consumption. In another embodiment, the MIF transmit module 516 is modified to perform the simple bit selection as described earlier.

FIG. 6 shows an AFE 600 of a modified 10GBase-T PHY module in accordance with one embodiment of the invention. The Analog Echo Cancellation module that normally couples the Tomlinson-Harashima Precoding (THP) 616 to the Echo Digital to Analog Converter (ECDAC) 630 in the prior art is removed to limit the power level of the 10GBase-T SFP+ module to meet the power requirements of SFP+ power level one or two. As a result, the THP module 616 is directly connected to the ECDAC 630. In another embodiment, the components of the ECDAC 630 are simplified when the Analog Echo Cancellation module is removed. In another embodiment, the Digital Echo Cancellation module 620, Near-End Cross Talk (NEXT) cancellation module 622, and the Feed Forward Equalizer (FFE) module 624 are simplified to limit the power level of the 10GBase-T SFP+ module to meet the power requirements of SFP+ power level one or two.

In addition to reducing the power dissipation, the latency of the 10GBase-T SFP+ module is reduced by removing the LDPC decoder. LDPC decoding is generally an iterative process where a full block of about 2048 bits is accumulated in approximately 205 nanoseconds before the decoding iterations begin. Decoding is done at a low clock speed and typically requires around 1.5 microseconds. By eliminating the decoder and using simple bit selection, this latency reduces to a few nanoseconds.

Furthermore, the large filters (not shown in FIG. 6) required for full implementation of the 10GBase-T PHY module are typically implemented in the frequency domain such as Fast Fourier Transform (FFT), multiplication, and Inverse FFT (IFFT). To reduce power consumption, the FFT and IFFT require buffering that introduces around 0.64 microseconds of latency. In one embodiment, the FFT and IFFT operations in the Block Processor 520 are simplified by using smaller blocks that reduce the buffering latency accordingly. The 10GBase-T SFP+ module 120 is also hot-pluggable when the SFI host is powered.

Although examples of the embodiments of the disclosed subject matter are described, one of ordinary skill in the relevant art will readily appreciate that many other methods of implementing the disclosed subject matter may alternatively be used. In the preceding description, various aspects of the disclosed subject matter have been described. For purposes of explanation, specific numbers, systems and configurations were set forth in order to provide a thorough understanding of the subject matter. However, it is apparent to one skilled in the relevant art having the benefit of this disclosure that the subject matter may be practiced without the specific details. In other instances, well-known features, components, or modules were omitted, simplified, combined, or split in order not to obscure the disclosed subject matter.

Various embodiments of the disclosed subject matter may be implemented in hardware, firmware, software, or combination thereof, and may be described by reference to or in conjunction with program code, such as instructions, functions, procedures, data structures, logic, application programs, design representations or formats for simulation, emulation, and fabrication of a design, which when accessed by a machine results in the machine performing tasks, defining abstract data types or low-level hardware contexts, or producing a result.

While the disclosed subject matter has been described with reference to illustrative embodiments, this description is not intended to be construed in a limiting sense. Various modifications of the illustrative embodiments, as well as other embodiments of the subject matter, which are apparent to persons skilled in the art to which the disclosed subject matter pertains are deemed to lie within the scope of the disclosed subject matter.

What is claimed is:

1. An apparatus comprising:
a 10GBase-T physical layer (PHY) module having a communication interface to:
receive 10GBase-T data from a link partner via the communication interface; and
process the 10GBase-T data into intermediate data; and
an interface module having a Small Form Factor Pluggable (SFP+) high speed serial electrical interface (SFI), communicatively coupled with the 10GBase-T PHY module to:
receive the intermediate data from the 10GBase-T PHY module;
process the intermediate data into 10GBase-R data; and
output the 10GBase-R data to a SFI host via the SFI.

2. The apparatus of claim 1, wherein the 10GBase-T data is incoming 10GBase-T data, the intermediate data is incoming intermediate data, and the 10GBase-R data is outgoing 10GBase-R data, and wherein the interface module is to:
receive incoming 10GBase-R data from the SFI host via the SFI; and
process the incoming 10GBase-R data into outgoing intermediate data, and wherein the 10GBase-T PHY module is to:
receive the outgoing intermediate data from the interface module;
process the outgoing intermediate data into outgoing 10GBase-T data; and
output the outgoing 10GBase-T data to the link partner via the communication interface.

3. The apparatus of claim 2 further comprising a buffer, communicatively coupled with the 10GBase-T PHY module and with the interface module to:
receive the outgoing intermediate data;
process the outgoing intermediate data to synchronize a data rate between the interface module and the 10GBase-T PHY module; and
send the processed outgoing intermediate data to the 10GBase-T PHY module.

4. The apparatus of claim 2, wherein the incoming and the outgoing intermediate data operate in accordance with 10 Gigabit Media Independent Interface (XGMII) format.

5. The apparatus of claim 2, wherein the power level of the apparatus is limited to SFP+ level one or level two.

6. The apparatus of claim 5, wherein the 10GBase-T PHY module comprises a Media Interface (MIF) transmit module directly coupled to a Receiver Synchronizer (RXSYNC) module to limit the power level of the apparatus.

7. The apparatus of claim 5, wherein the 10GBase-T PHY module comprises a Tomlinson-Harashima Precoding (THP) module directly coupled to an Echo Digital to Analog Converter (ECDAC) to limit the power level of the apparatus.

8. A system comprising:
a link partner having a communication interface to send 10GBase-T data via the communication interface; and
a Small Form Factor Pluggable (SFP+) module comprising:
a 10GBase-T physical layer (PHY) to:
receive 10GBase-T data from the link partner via the communication interface; and
process the 10GBase-T data into intermediate data; and
an interface module having a SFP+ high speed serial electrical interface (SFI), communicatively coupled with the 10GBase-T PHY module to:
receive the intermediate data from the 10GBase-T PHY module; and
process the intermediate data into 10GBase-R data; and
a SFI host communicatively coupled with the SFP+ module to
receive the 10GBase-R data via the SFI.

9. The system of claim 8, wherein the 10GBase-T data is incoming 10GBase-T data, the intermediate data is incoming intermediate data, and the 10GBase-R data is outgoing 10GBase-R data, and wherein the interface module is to:
receive incoming 10GBase-R data from the SFI host via the SFI; and
process the incoming 10GBase-R data into outgoing intermediate data, and wherein the 10GBase-T PHY module is to:
receive the outgoing intermediate data from the interface module; and
process the outgoing intermediate data into outgoing 10GBase-T data, and wherein the link partner is to receive the outgoing 10GBase-T data via the communication interface.

10. The SFP+ module of claim 9 further comprising a buffer, communicatively coupled with the 10GBase-T PHY module and with the interface module to:
receive the outgoing intermediate data;
process the outgoing intermediate data to synchronize a data rate between the interface module and the 10GBase-T PHY module; and
send the processed outgoing intermediate data to the 10GBase-T PHY module.

11. The SFP+ module of claim 9, wherein the incoming and the outgoing intermediate data operate in accordance with 10 Gigabit Media Independent Interface (XGMII) format.

12. The SFP+ module of claim 9, wherein the power level of the SFP+ module is limited to SFP+ level one or level two.

13. The SFP+ module of claim 12, wherein the 10GBase-T PHY module comprises a a Media Interface (MIF) transmit module directly coupled to a Receiver Synchronizer (RXSYNC) module to limit the power level of the SFP+ module.

14. The SFP+ module of claim 12, wherein the 10GBase-T PHY module comprises a Tomlinson-Harashima Precoding (THP) module directly coupled to an Echo Digital to Analog Converter (ECDAC) to limit the power level of the SFP+ module.

15. The system of claim 9, wherein the communication interface has a Registered Jack 45 (RJ45) connection that supports Category 5, 5E, 6, 6A and 7 twisted pair cables.

16. The system of claim 9, wherein the apparatus is hot pluggable when the SFI host is powered.

17. A method comprising:
receiving 10GBase-T data from a link partner via a communication interface;
processing the 10GBase-T data into intermediate data;
receiving the intermediate data by a Small Form Factor Pluggable (SFP+) module;
processing the intermediate data into 10GBase-R data; and
receiving by a SFP+ high speed serial electrical interface (SFI) host the 10GBase-R data via a SFI.

18. The method of claim 17, wherein the 10GBase-T data is incoming 10GBase-T data, the intermediate data is incoming intermediate data, and the 10GBase-R data is outgoing 10GBase-R data, further comprising:
receiving incoming 10GBase-R data from the SFI host via the SFI;
processing the incoming 10GBase-R data into outgoing intermediate data;
receiving the outgoing intermediate data;
processing the outgoing intermediate data into outgoing 10GBase-T data; and
receiving the outgoing 10GBase-T data by the link partner via the communication interface.

19. The method of claim 18, further comprising processing the outgoing intermediate data to synchronize a data rate between the incoming 10GBase-R data and the outgoing intermediate data.
